(19) United States
(12) Patent Application Publication
(10) Pub. No.: US 2006/0267905 A1
(43) Pub. Date: Nov. 30, 2006

(54) Liquid crystal display apparatus capable of controlling range of viewing angle

(75) Inventors: Toshiharu Nishino, Hamura-shi (JP); Kunpei Kobayashi, Tachikawa-shi (JP); Norihiro Arai, Hino-shi (JP); Hideki Sashida, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/442,916

(22) Filed: May 30, 2006

(30) Foreign Application Priority Data
May 31, 2005 (JP) 2005-160645
Oct. 31, 2005 (JP) 2005-317253

(51) Int. Cl. G09G 3/36

(52) U.S. Cl. 345/98

(57) ABSTRACT

A liquid crystal display apparatus includes first and second electrodes which are provided on opposed inner surface of a first substrate, and insulated from each other to generate in a liquid crystal layer provided between the substrates a transverse electric field in a direction substantially parallel to substrate surfaces. A third electrode is provided on an inner surface of a second substrate in accordance with an entire region of a pixel defined by a region in which an alignment state of liquid crystal molecules is controlled by the transverse electric field. An image display circuit supplies a display drive voltage corresponding to image data between the first and second electrodes to generate the transverse electric field. A viewing angle control circuit supplies a viewing angle control voltage between at least one of the first and second electrodes and the third electrode to generate between these electrodes a vertical electric field.

### CROSS-REFERENCE TO RELATED APPLICATIONS

This application is based upon and claims the benefit of priority from prior Japanese Patent Applications No. 2005-160645, filed May 31, 2005; and No. 2005-317253, filed Oct. 31, 2005, the entire contents of both of which are incorporated herein by reference.

### BACKGROUND OF THE INVENTION

1. Field of the Invention

The present invention relates to a viewing angle control type liquid crystal display apparatus capable of controlling a range of a viewing angle.

2. Description of the Related Art

As a liquid crystal display apparatus, there is known an apparatus including a transverse electric field type liquid crystal display device display device having a structure in which a liquid crystal layer is interposed between a pair of substrates facing each other through a gap, a plurality of first and second electrodes which generate a transverse electric field in a direction substantially parallel to the substrate surfaces in the liquid crystal layer are provided to be insulated from each other on one of opposed inner surfaces of the pair of substrates, and a plurality of pixels each formed of a region where an alignment state of liquid crystal molecules in the liquid crystal layer is controlled by the transverse electric field generated between the first and second electrodes are arranged in a matrix form in a row direction and a column direction.

This transverse electric field type liquid crystal display device display device generates a transverse electric field corresponding to image data between the first and second electrodes provided on the inner surface of one substrate and controls the alignment direction (long-axis direction) of liquid crystal molecules by the transverse electric field in a plane substantially parallel to the substrate surfaces to display an image, and it has a wide viewing angle.

For example, a liquid crystal display apparatus mounted in an electronic device such as a mobile phone requires viewing angle controllability which can switch a viewing angle of display to a wide viewing angle and a narrow viewing angle which prevents display from being seen by persons other than a user of the liquid crystal display apparatus.

As a viewing angle control type liquid crystal display apparatus including the transverse electric field type liquid crystal display device, there is conventionally an apparatus having a configuration in which a third electrode facing one of first and second electrodes is provided on an inner surface of one substrate of the liquid crystal display device, i.e., a substrate facing the other substrate on which the first and second electrodes which generate a transverse electric field are provided. In such an apparatus, a voltage having the same value as a voltage corresponding to image data applied to a part between the first and second electrodes or a value which is half of a voltage corresponding to the image data is applied between one of the first and second electrodes and the third electrode to distort equipotential lines of the transverse electric field, and liquid crystal molecules are aligned in an alignment state corresponding to the distortion of the equipotential line to narrow the viewing angle of display (see Jpn. Pat. Appln. KOKAI Publication No. 1999-30783).

The conventional viewing angle control type liquid crystal display apparatus applies a voltage having the same value as a voltage corresponding to image data applied between the first and second electrodes or a value which is 1/n of a voltage corresponding to the image data between one of the first and second electrodes on the inner surface of one substrate of the liquid crystal display device and the third electrode on the inner surface of the other substrate to distort equipotential lines of the transverse electric field, and aligns liquid crystal molecules in an alignment state corresponding to the distortion of the equipotential lines to narrow the viewing angle of display. Therefore, the viewing angle fluctuates in accordance with the image data, and stable viewing angle control cannot be performed.

### BRIEF SUMMARY OF THE INVENTION

It is an object of the present invention to provide a liquid crystal display apparatus which is provided with a transverse electric field type liquid crystal display device and can perform stable viewing angle control.

According to a first aspect of the present invention, there is provided a liquid crystal display apparatus comprising:

a pair of substrates arranged to face each other with a gap therebetween;

a liquid crystal layer interposed between the pair of substrates;

first and second electrodes which are provided on opposed inner surface side of one of the pair of substrates, and insulated from each other to generate in the liquid crystal layer a transverse electric field in a direction substantially parallel to the substrate surfaces;

a third electrode which is provided on an inner surface side of the other substrate in accordance with an entire region of a pixel defined by a region in which an alignment state of liquid crystal molecules is controlled by the transverse electric field generated between the first and second electrodes;

an image display circuit which supplies a display drive voltage corresponding to image data between the first and second electrodes to generate the transverse electric field between the first and second electrodes;

a viewing angle control circuit which supplies a viewing angle control voltage different from the display drive voltage between at least one of the first and second electrodes and the third electrode to generate between these electrodes a vertical electric field in a direction substantially parallel to a thickness direction of the liquid crystal layer; and

a pair of polarizing plates arranged with the pair of substrates therebetween.

In this liquid crystal display apparatus, it is preferable that the first electrode of the first and second electrodes provided on an inner surface of one substrate is formed in accordance with at least entire region of a pixel, the second electrode is formed into a shape having an area smaller than that of the first electrode and facing the first electrode at an edge portion on an insulating film covering the first electrode, and the viewing angle control circuit includes a viewing angle controlling voltage supply circuit which supplies a viewing angle controlling voltage between the first electrode and a third electrode provided on an inner surface of the other substrate. In this case, it is desirable for the second electrode to be formed of a comb-like electroconductive film patterned into a comb-like shape having a plurality of tooth portions. Alternatively, it is desirable for the second electrode to be formed of a slit formed electroconductive film patterned into a shape having a plurality of slits. Further, it is desirable that alignment films are respectively formed on the inner surfaces of the pair of substrates and the respective alignment films are subjected to an aligning treatment in opposite directions along a direction obliquely crossing a length direction of the edge portion of the second electrode at a predetermined angle.

Furthermore, in this liquid crystal display apparatus, it is preferable for the first and second electrodes provided on the inner surface of one substrate to be provided in a direction along the substrate surfaces through a gap. In this case, it is desirable that the first electrode is formed of a first comb-like electroconductive film patterned into a comb-like shape having a plurality of tooth portions and the second electrode is formed of a second comb-like electroconductive film patterned into a comb-like shape having a plurality of tooth portions which are respective adjacent to the plurality of tooth portions of the first comb-like electroconductive film through a gap.

Moreover, in this liquid crystal display apparatus, it is preferable that alignment films are respectively formed on the inner surfaces of the pair of substrates and the respective alignment films are subjected to an aligning treatment in opposite directions along a direction obliquely crossing a direction of a transverse electric field generated between the first and second electrodes at a predetermined angle.

Additionally, in this liquid crystal display apparatus, it is preferable that alignment films are respectively formed on the inner surfaces of the pair of substrates, the respective alignment films are subjected to an aligning treatment in opposite directions along a direction substantially parallel to a vertical direction of a screen of the liquid crystal display apparatus, the polarizing plate on an observation side of the pair of polarizing plates is arranged in such a manner that its transmission axis becomes substantially parallel to the aligning treatment, and the polarizing plate on the opposite side is arranged in such a manner that its transmission axis becomes substantially perpendicular or parallel to the transmission axis of the polarizing plate on the observation side.

According to a second aspect of the present invention, there is provided a liquid crystal display apparatus comprising:

a liquid crystal display device including:

a pair of substrates arranged to face each other with a gap therebetween,

a liquid crystal layer interposed between the pair of substrates,

first and second electrodes which are arranged on opposed inner surface sides of one of the pair of substrates, and insulated from each other to generate in the liquid crystal layer a transverse electric field in a direction substantially parallel to substrate substrates, and

a third electrode which is provided on an inner surface side of the other substrate in accordance with an entire region of each of a plurality of pixels defined by a region in which an alignment state of liquid crystal molecules is controlled by at least the transverse electric field generated between the first and second electrodes,

the plurality of pixels being arranged in a matrix form in a row direction and a column direction; and

a drive circuit which sequentially selects the plurality of pixels arranged in the matrix form in the liquid crystal display device in accordance with each pixel row of the plurality of pixels arranged in the row direction to generate a first signal which is applied to the first electrode to control the plurality of pixels in the pixel rows in accordance with each selected pixel row and whose potential varies in accordance with each horizontal scanning period assigned to each pixel row, a second signal which has a potential difference corresponding to image data with respect to the first signal and is applied to the second electrode, and a third signal whose potential varies in synchronization with a change in potential of the first signal, has a predetermined potential difference with respect to each of the first signal and the second signal and is selectively applied to the third electrode.

In this liquid crystal display apparatus, it is preferable for the drive circuit to selectively apply a third signal whose potential varies in antiphase with respect to a change in potential of a first signal to the third electrode of the liquid crystal display device. Alternatively, it is preferable for the drive circuit to selectively apply a third signal whose potential varies in phase with respect to a change in potential of the first signal and whose potential has an absolute value different from the potential of the first signal to the third electrode of the liquid crystal display device.

In this liquid crystal display apparatus, it is preferable for the drive circuit to include: a first signal generation circuit which generates a first signal whose potential varies in accordance with each horizontal scanning period; a second signal generation circuit which generates a second signal which supplies to the second electrode a potential which changes to a value having a potential difference corresponding to image data with respect to a potential of the first signal in accordance with each horizontal scanning period; a third signal generation circuit which generates a third signal whose potential varies in antiphase or in phase with respect to a change in potential of the first signal; and selecting means for selecting application of the third signal to the third electrode of the liquid crystal display device.

Furthermore, in this liquid crystal display apparatus, it is preferable that the liquid crystal display device includes a plurality of active elements each of which is arranged in accordance with each pixel and has an input electrode and an output electrode for signals and a control electrode which controls electrical conduction between the input and output electrodes. The control electrode is connected with a scanning line in accordance with each row, the input electrode is connected with a signal line in accordance with each column, and the output electrode is connected with the second electrode. The drive circuit includes: a common signal generation circuit which generates a first signal whose potential varies in accordance with each horizontal scanning period and supplies the first signal to the first electrode of the liquid crystal display device; an image signal generation circuit which generates a second signal which supplies to the second electrode a voltage whose potential varies to a value having a potential difference corresponding to image data with respect to a potential of the first signal in accordance with each horizontal scanning period, and supplies the second signal to the signal line; a scanning signal generation circuit which generates a scanning signal which achieves electrical conduction between the input electrode and the output electrode of the active element in selected row in one horizontal scanning period, and supplies the scanning signal to the scanning line; a viewing angle control signal generation circuit which generates a third signal whose potential varies in antiphase or in phase with respect to a change in potential of the first signal; and a signal selection circuit which selects supply of the third signal to the third electrode of the liquid crystal display device. In this case, it is preferable for each of the plurality of active elements to be formed of a thin film transistor having a gate electrode connected with the scanning line, one of a drain electrode and a source electrode connected with the signal line and the other one connected with the second electrode.

Moreover, in this liquid crystal display apparatus, it is preferable that the first electrode of the first and second electrodes on the inner surface of one substrate in the liquid crystal display device is formed in accordance with at least an entire region of a pixel, and the second electrode is formed into a shape having an area smaller than that of the pixel and facing the first electrode at an edge portion on an insulating film covering the first electrode. In this case, it is desirable for the second electrode to be formed of a comb-like electroconductive film patterned into a comb-like shape having a plurality of tooth portions. Alternatively, it is desirable for the second electrode to be formed of a slit formed electroconductive film patterned into a shape having a plurality of slits.

Further, in this liquid crystal display apparatus, it is preferable for the liquid crystal display device to include: homogeneous alignment films which are respectively formed on the inner surfaces of the pair of substrates, define an alignment direction of liquid crystal molecules at the time of no electric field, and subjected to an alignment treatment in opposite directions along a direction substantially parallel to a vertical direction of a screen of the liquid crystal display device; and a pair of polarizing plates arranged with the pair of substrates therebetween, the polarizing plate on an observation side being provided in such a manner that its transmission axis becomes substantially parallel to the alignment treatment of the alignment films, the polarizing plate on an opposite side of the observation side being provided in such a manner that its transmission axis becomes substantially perpendicular or parallel to the transmission axis of the polarizing plate on the observation side.

According to a third aspect of the present invention, there is provided a liquid crystal display apparatus comprising:

liquid crystal displaying means having a liquid crystal layer interposed between a pair of substrates arranged to face each other with a gap therebetween, first and second electrodes which generate in the liquid crystal layer a transverse electric field in a direction substantially parallel to the substrate surfaces, and a third electrode which generates in the liquid crystal layer a vertical electric field in a direction substantially parallel to a thickness direction of the liquid crystal layer, the liquid crystal displaying means controlling an alignment state of molecules of the liquid crystal layer by the transverse electric field in accordance with each pixel defined by a region of the liquid crystal layer whose alignment is controlled by the transverse electric field generated by the first electrode and the second electrode, thereby displaying an image by using the plurality of pixels;

image displaying means for generating a display drive signal corresponding to image data supplied thereto, and supplying the generated display drive signal to the first electrode and the second electrode to generate a transverse electric field corresponding to the image data in accordance with each of the plurality of pixels; and

viewing angle controlling means for receiving a viewing angle selection signal for selection of a viewing angle to be synchronized with the display drive signal, generating a viewing angle controlling voltage different from the display drive signal, and supplying the generated voltage to the third electrode to generate the vertical electric field in the liquid crystal layer of the plurality of pixels, thereby restricting a range of the viewing angle.

According to the liquid crystal display apparatus based on the first aspect of the present invention, a plurality of first and second electrodes which generate a transverse electric field parallel to substrate surfaces are provided on an inner surface of one substrate of the liquid crystal display device, a third electrode which generates a vertical electric field parallel to a thickness direction of a liquid crystal layer is provided on an opposed substrate surface, and the vertical electric field which is independent from the transverse electric field is selectively applied to the liquid crystal layer. Therefore, it is possible to selectively perform wide viewing angle display when driving using the transverse electric field alone and narrow viewing angle display when driving using both the transverse electric field and the vertical electric field.

Furthermore, according to the liquid crystal display apparatus based on the second aspect of the present invention, the plurality of first and second electrodes which generate a transverse electric field parallel to the substrate surfaces are provided on the inner surface of one substrate of the liquid crystal display device, and the third electrode which generates a vertical electric field parallel to the thickness direction of the liquid crystal layer is provided on the opposed substrate surface. The first and second signals are supplied to a part between the first and second electrodes to apply a transverse electric field corresponding to image data, and the third signal whose potential varies in synchronization with a change in potential of a signal supplied to the first electrode is applied to the third electrode. As a result, a vertical electric field in a direction substantially parallel to the thickness direction of the liquid crystal layer is applied. Therefore, it is possible to selectively perform wide viewing angle display when driving using the transverse electric field alone and narrow viewing angle display when driving using both the transverse electric field and the vertical electric field.

Moreover, according to the liquid crystal display apparatus based on the third aspect of the present invention, there are provided: liquid crystal displaying means having the first and second electrodes which generate a transverse electric field parallel to the substrate surfaces, and the third electrode which generates a vertical electric field parallel to the thickness direction of the liquid crystal layer; image displaying means for generating a transverse electric field corresponding to image data to a part between the first and second electrodes; and viewing angle controlling means receiving a viewing angle selection signal for selection of a viewing angle to be synchronized with the display drive signal, and supplying a viewing angle controlling voltage different from the display drive signal to the third electrode to generate the vertical electric field in the liquid crystal layer of the pixel, thereby restricting a range of the viewing angle. Therefore, it is possible to selectively perform wide viewing angle display when driving using the transverse electric field and narrow viewing angle display when driving using both the transverse electric field and the vertical electric field.

### BRIEF DESCRIPTION OF THE SEVERAL VIEWS OF THE DRAWING

FIG. 1 is a front view showing an electronic device which may be provided with a liquid crystal display apparatus according to any one of embodiments of the present invention;

FIG. 2 is a plan view showing a part of one substrate in a liquid crystal display device of a liquid crystal display apparatus according to a first embodiment of the present invention;

FIG. 3 is a cross-sectional view showing a part of the liquid crystal display device of FIG. 2;

FIG. 4 is a view showing aligning treatment directions of alignment films respectively provided on inner surfaces of a pair of substrates of the liquid crystal display device and directions of transmission axes of polarizing plates;

FIG. 5 is a block circuit diagram of a drive circuit;

FIG. 6 is a circuit diagram showing a signal generation circuit which generates a common signal and a viewing angle control signal;

FIG. 7 is a view showing a scanning signal, a common signal, a white data signal and a black data signal applied to the liquid crystal display device, a potential of a signal electrode at the time of white display and black display, a voltage between a common electrode and the signal electrode at the time of white display, and a voltage between the common electrode and the signal electrode at the time of black display;

FIG. 8 is a view showing a voltage between the common electrode and an opposed electrode and a voltage between the signal electrode and the opposed electrode at the time of black display when a viewing angle control signal which is in antiphase with respect to the common signal is applied to the opposed electrode of the liquid crystal display device;

FIG. 9 is a view showing a voltage between the common electrode and the opposed electrode and a voltage between the signal electrode and the opposed electrode at the time of white display when the viewing angle control signal which is in phase with respect to the common signal is applied to the opposed electrode;

FIG. 10 is a view showing a voltage between the common electrode and the opposed electrode and a voltage between the signal electrode and the opposed electrode at the time of black display when the viewing angle control signal which is in phase with respect to the common signal is applied to the opposed electrode;

FIG. 11 is a view showing a voltage between the common electrode and the opposed electrode and a voltage between the signal electrode and the opposed electrode at the time of white display when the viewing angle control signal which is in phase with respect to the common signal is applied to the opposed electrode;

FIGS. 12A and 12B are a schematic view showing a supply state of a signal in case of generating a transverse electric field corresponding to a black data signal between the common electrode and the signal electrode in one pixel when the viewing angle control signal is not applied to the opposed electrode, and a view schematically showing a change in alignment of liquid crystal molecules at this time;

FIGS. 13A and 13B are a schematic view showing a supply state of a signal in case of generating a transverse electric field corresponding to a white data signal between the common electrode and the signal electrode in one pixel when the viewing angle control signal is not applied to the opposed electrode, and a view schematically showing a change in alignment of the liquid crystal molecules at this time;

FIGS. 14A and 14B are a schematic view showing a supply state of a signal in case of generating a transverse electric field corresponding to the black data signal between the common electrode and the signal electrode in one pixel when the viewing angle control signal is applied to the opposed electrode, and a view schematically showing a change in alignment of the liquid crystal molecules at this time;

FIGS. 15A and 15B are a schematic view showing a supply state of a signal in case of generating a transverse electric field corresponding to the white data signal between the common electrode and the signal electrode in one pixel when the viewing angle control signal is applied to the opposed electrode, and a view schematically showing a change in alignment of the liquid crystal molecules at this time;

FIG. 16 is a plan view showing a part of one substrate in a liquid crystal display device according to a second embodiment of the present invention;

FIG. 17 is a plan view showing a part of one substrate in a liquid crystal display device according to a third embodiment of the present invention; and

FIG. 18 is a cross-sectional view showing a part of the liquid crystal display device according to the third embodiment.

### DETAILED DESCRIPTION OF THE INVENTION

### First Embodiment

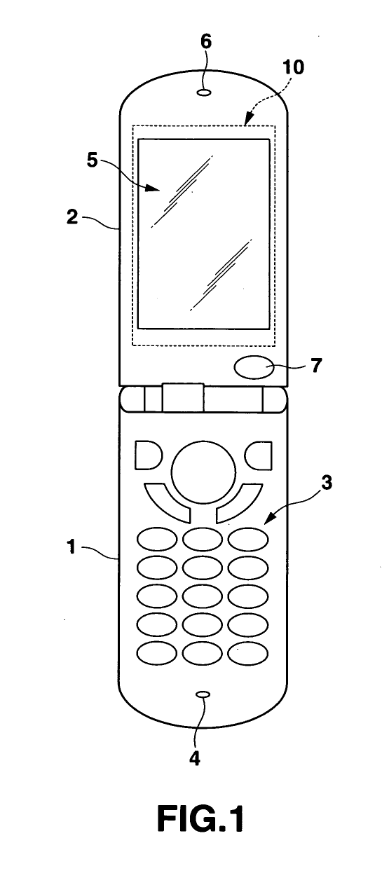

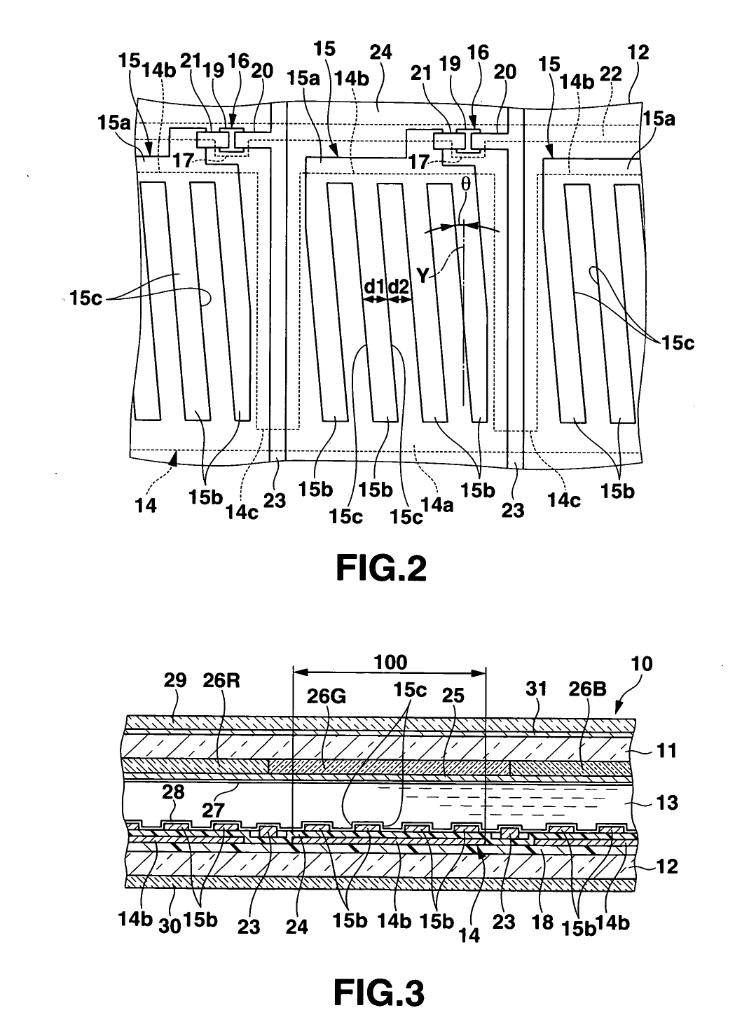

FIGS. 1 to 15A and 15B show a first embodiment of the present invention, wherein FIG. 1 is a front view of an electronic device including a liquid crystal display apparatus; FIG. 2, a plan view showing a part of one substrate in a liquid crystal display device of the liquid crystal display apparatus; and FIG. 3 is a cross-sectional view showing a part of the liquid crystal display device.

The electronic device shown in FIG. 1 will be described first. This electronic device is a flip type mobile phone constituted of: a phone main body 1; and a cover body 2 which has a base end pivoted at an end of the phone main body 1 and swivels between an opened state where it protrudes toward the outside of the phone main body 1 as shown in the figure and a closed state where it lies over the phone main body 1. A keyboard portion 3 and a microphone portion 4 are provided on a front surface of the phone main body 1 (a surface on which the cover body 2 is superimposed). A display portion 5 and a speaker portion 6 are provided on a front surface of the cover body 2 (a surface facing the front surface of the phone main body 1 when folded).

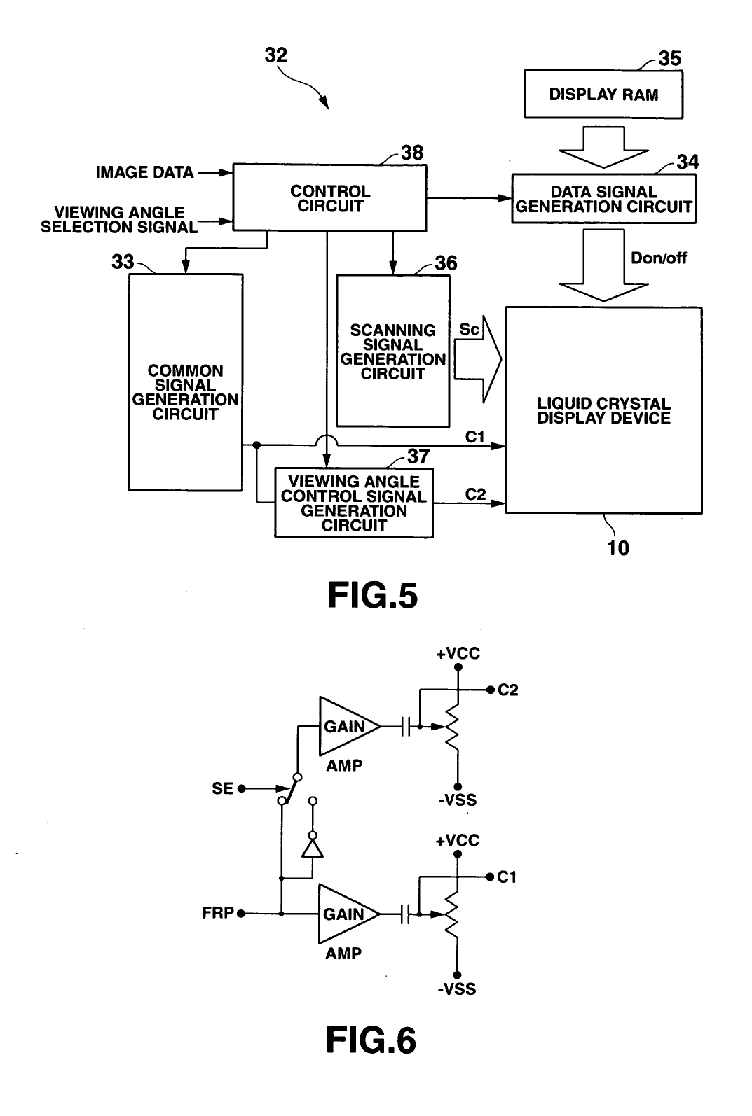

The liquid crystal display apparatus will now be described. The liquid crystal display apparatus according to this embodiment is provided with: a liquid crystal display device 10 arranged in the cover body 2 of the mobile phone to face the display portion 5; a drive circuit 32 (see FIG. 5) of the liquid crystal display device 10; and a surface light source (not shown) which is arranged on an opposite side of an observation side of the liquid crystal display device and irradiates the liquid crystal display device 10 with illumination light.

As shown in FIGS. 2 and 3, in the liquid crystal display device 10, a liquid crystal layer 13 made of a nematic liquid crystal having positive dielectric anisotropy is interposed between a pair of transparent substrates 11 and 12 facing each other through a gap. A plurality of first transparent electrodes 14 and second transparent electrodes 15 having a plurality of segments, which generate in the liquid crystal layer 13 a transverse electric field in a direction substantially parallel to a surface of the substrate 11 are provided to be insulated from each other on one of opposed inner surfaces of the pair of substrates 11 and 12, e.g., an inner surface of the substrate 12 opposite to the observation side (an upper side in FIG. 3). The liquid crystal display device is a transverse electric field type liquid crystal display device including a plurality of pixels 100 arranged in a matrix form along a row direction (a horizontal direction in FIG. 2) and a column direction (a vertical direction in FIG. 2). Each pixel 100 in this liquid crystal display device is defined by a region where each of the second transparent electrodes 15 corresponds to each of the first transparent electrodes 14, and where an alignment state of liquid crystal molecules in the liquid crystal layer 13 is controlled by the transverse electric field generated between the first transparent electrode 14 and the individual segments of the second transparent electrodes 15. This liquid crystal display device 10 includes on an inner surface of the other substrate, i.e., the substrate 11 on the observation side, a third transparent electrode 25 provided in accordance with at least an entire region of each of the plurality of pixels 100.

The first transparent electrode 14 will be referred to as a common electrode hereinafter; the second transparent electrode 15, a signal electrode; the third transparent electrode 25, an opposed electrode; one substrate 12 on which the common electrodes 14 and the signal electrodes 15 are provided, a pixel substrate; and the other substrate on which the opposed electrode 25 is provided, an opposed substrate.

Of the common electrode 14 and the signal electrode 15 on the inner surface of the pixel electrode 12, the common electrode 14 is formed in accordance with at least an entire or substantially entire region of the pixel 100. The signal electrodes 15 are formed into a shape having an area smaller than the pixel 100 in total on an interlayer insulating film 24 provided to cover the common electrode 14, and then edge portions 15C face the common electrode 14.

This liquid crystal display device is an active matrix liquid crystal display device , and includes on the inner surface of the pixel electrode 12 an active element 16 arranged in accordance with each of the plurality of pixels 100 arranged in a matrix form. This active element 16 has an input electrode 20 and an output electrode 21 for signals, and a control electrode 17 which controls electrical conduction between the input and output electrodes 20, 21. The control electrodes 17 are connected with a scanning line 22 in accordance with each row, the input electrodes 20 are connected with a signal line 23 in accordance with each column, and the output electrodes 21 are connected with the signal electrode 15.

The active element 16 may be a thin film transistor (which will be referred to as a TFT hereinafter), and it is constituted of a gate electrode (the control electrode) 17 formed on the substrate surface of the pixel substrate 12, a gate insulating film 18 which is formed on a substantially entire surface of the pixel substrate 12 to cover the gate electrode 17, an i-type semiconductor film 19 which is formed to face the gate electrode 17 on this gate insulating film 18, and a drain electrode (the input electrode) 20 and a source electrode (the output electrode) 21 which are provided on both side portions of the i-type semiconductor film 19 through an n-type semiconductor film (not shown).

The scanning line 22 is formed by connecting the gate electrode 17 of the TFT 16 in each row to each of pixel rows consisting of the plurality of pixels 100 arranged in the row direction on the substrate surface of the pixel substrate 12. The signal line 23 is provided on the gate insulating film 18 in accordance with each of pixel columns consisting of the plurality of pixels 100 arranged in the column direction, and connected with the drain electrode 20 of the TFT 16 in each column.

A terminal arrangement portion (not shown) which protrudes toward the outside of the opposed substrate 11 is formed at an edge portion of the pixel substrate 12. The scanning lines 22 and the signal lines 23 are connected with a plurality of scanning line terminals and signal line terminals provided at the terminal arrangement portion.

As shown in FIGS. 2 and 3, the common electrode 14 is formed of transparent electroconductive films 14a provided on the gate insulating film 18 along the entire length in accordance with each of the pixel rows, and these transparent electroconductive films 14a are respectively connected with a plurality of common electrode terminals provided at the terminal arrangement portion of the pixel forming electrode substrate 12.

In this embodiment, the electroconductive film 14a is formed into a shape constituted of a plurality of rectangular electrode portions 14b each corresponding to the entire region of each pixel 100 in the pixel row, and a lead portion 14c which connects the adjacent electrode portions with each other on one end side thereof. However, this electroconductive film 14a may be formed to have a width corresponding to the entire region of the pixel 100 along the entire length thereof.

Further, the signal electrode 15 is provided to correspond to each pixel 100 on the interlayer insulating film 24, constituted of a comb-like electroconductive film 15a patterned in to a comb-like shape having a plurality of segments or tooth portions 15b, and connected with the source electrode 21 of the TFT 16 at one end of a base portion connecting the respective tooth portions 15b of the comb-like electroconductive film 15a with each other.

The interlayer insulating film 24 is entirely provided on an upper side of the pixel substrate 12 to cover the common electrode 14, the TFT 16, the scanning line 22, and an exposed surface portion of the substrate 12. The comb-like electroconductive film 15a is connected with the source electrode 21 of the TFT 16 in a contact hole (not shown) provided in the interlayer insulating film 24.

The comb-like electroconductive film 15a has four elongated segments or tooth portions 15b formed at equal intervals, and a region in which an alignment state of liquid crystal molecules is substantially homogeneously controlled by a transverse electric field generated between these four tooth portions 15b and the common electrode 14 (rectangular electrode portion 14b) forms one pixel 100.

Each tooth portion 15b of the comb-like electroconductive film 15a is formed into an elongated shape along a direction inclined with respect to the vertical direction of a screen of the liquid crystal display device, i.e., a vertical axis Y of the screen in one of left and right directions at a predetermined angle, e.g., an angle θ of 5° to 15°. A ratio d2/d1 of a width d1 of each of the tooth portions 15b and a gap d2 between the tooth portions 15b adjacent to each other may be set to 1/3 to 3/1, or preferably 1/1.

The opposed electrode 25 on the inner surface of the opposed substrate 11 is formed of one film-like electroconductive film facing the entire arrangement region of the plurality of pixels 100.

This liquid crystal display device is a color image display device including color filters 26R, 26G and 26B of three colors, i.e., red, green and blue corresponding to each of the plurality of pixels 100. The color filters 26R, 26G an 26B are formed on the substrate surface of the opposed substrate 11, and the opposed electrode 25 is formed thereon.

Homogeneous alignment films 27 and 28 are respectively provided on the inner surface sides of the opposed substrate 11 and pixel electrode 12 to respectively cover the opposed electrode 25, and the common electrode 14 and the signal electrode 15. These alignment films 27 and 28 are respectively subjected to rubbing (an alignment treatment) in opposite directions along a direction substantially parallel to the vertical axis Y in the vertical direction of the screen.

Both substrate 11, 12 are bonded through a frame-like sealing material (not shown) which surrounds the arrangement region of the plurality of pixels 100, i.e., a screen region of the liquid crystal display device. The opposed electrode 25 is electrically connected with an opposed electrode terminal provided at a terminal arrangement portion of the pixel forming electrode substrate 12 through a non-illustrated cross connecting portion at a substrate bonding portion formed by the sealing material.

The liquid crystal layer 13 is interposed in a region surrounded by the sealing material between the opposed substrate 11 and the pixel substrate 12, and its liquid crystal molecules are aligned substantially parallel to the surfaces of the substrates 11 and 12 with their long axes being aligned in the alignment treatment direction (a direction of the vertical axis Y) of the alignment films 27 and 28.

A value of Δnd (a product of a refractive index anisotropy Δn of the liquid crystal and a thickness d of the liquid crystal layer) in a state where the liquid crystal molecules of this liquid crystal display device are aligned substantially parallel to the surfaces of the substrates 11 and 12 with their long axes being aligned in the aligning treatment directions of the alignment films 27 and 28 is set in the vicinity of substantially 275 nm which is a value of half of an intermediate wavelength in a visible light band.

Further, this liquid crystal display device is provided with a pair of polarizing plates 29 and 30 arranged with the pair of substrates 11 and 12 therebetween.

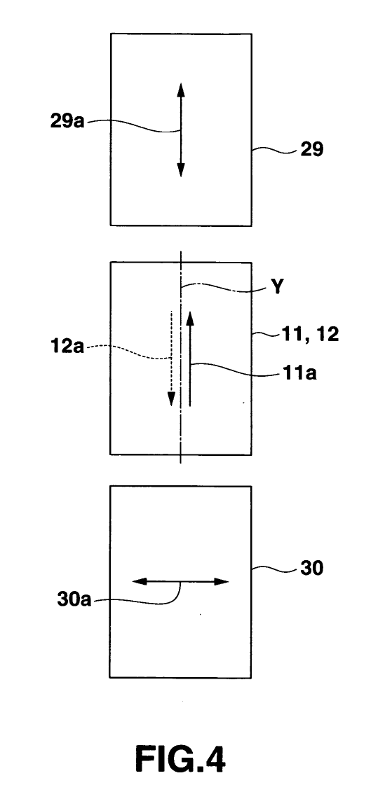

FIG. 4 shows aligning treatment directions (rubbing directions) 11a and 12a of the alignment films 27 and 28 on the opposed substrate 11 and the image forming electrode substrate 12 in the liquid crystal display device, and directions of transmission axes 29a and 30a of the pair of polarizing plates 29 and 30.

As shown in FIG. 4, the alignment films 27 and 28 of the opposed substrate 11 and the pixel forming electrode substrate 12 are subjected to an aligning treatment in opposite directions to each other along a direction substantially parallel to the vertical direction of the screen, i.e., the vertical axis Y of the screen. Of the pair of polarizing plates 29 and 30, the polarizing plate 29 on the observation side is provided in such a manner that its transmission axis 29a becomes substantially parallel to the aligning treatment directions 11a and 12a, and the polarizing plate 30 on the opposite side is provided in such a manner that its transmission axis 30a becomes substantially perpendicular (or parallel) to the transmission axis 29a of the polarizing plate 29 on the observation side.

It is to be noted that the transmission axis 29a of the observation-side polarizing plate 29 and the transmission axis 30a of the opposite-side polarizing plate 30 are set to be perpendicular to each other to allow the liquid crystal display device to perform display in a normally black mode.

The aligning treatment directions (the rubbing directions) of the alignment films 27 and 28 obliquely cross a direction of a transverse electric field generated between the common electrode 14 and the signal electrode 15 at a predetermined angle.

That is, the transverse electric field generated between the common electrode 14 and the signal electrode 15 is an electric field in a direction substantially perpendicular to a length direction of the edge 15C of each tooth portion 15b of the comb-like electroconductive film 15a. In this embodiment, as described above, each tooth portion 15b of the comb-like electroconductive film 15a is formed into an elongated shape along a direction inclined with respect to the vertical axis Y of the vertical direction of the screen in one of left and right directions at a predetermined angle, e.g., an angle θ of 5° to 15° , and the alignment films 27 and 28 are subjected to the aligning treatment in directions substantially parallel to the vertical axis Y. Therefore, the aligning treatment directions of the alignment films 27 and 28 cross a direction of the transverse electric field at the angle of 5° to 15°.

Furthermore, this liquid crystal display device is provided with one film-like transparent electroconductive film 31 which blocks off static electricity from the outside. This electrostatic blocking electroconductive film 31 is provided between the opposed substrate 11 as the observation-side substrate and the observation-side polarizing plate 29 arranged on an outer surface of the opposed substrate 11.

The liquid crystal display device is driven by a drive circuit 32 shown in FIG. 5. This drive circuit 32 generates a first signal (which will be referred to as a common signal hereinafter) whose potential varies in accordance with each horizontal scanning period 1 h assigned to each pixel row and which is applied to the common electrode 14, a second signal (which will be referred to as a data signal hereinafter) which has a potential with a potential difference corresponding to image data with respect to the common signal and is applied to the signal electrode 15, and a third signal (which will be referred to as a viewing angle control signal hereinafter) whose potential varies in synchronization with a change in potential of the first signal, has a potential with a predetermined potential difference with respect to each of the common signal and the data signal and is applied to the opposed electrode 25. The common signal is a signal which sequentially selects the plurality of pixels 100 arranged in a matrix form in the liquid crystal display device in accordance with the respective pixel rows of the plurality of pixels 100 arranged in the row direction, thereby controlling lighting of the pixels 100.

That is, this driving circuit or means 32 is constituted of a first signal generation circuit which generates the common signal whose potential varies in accordance with each horizontal scanning period 1 h of each row, a second signal generation circuit which generates the data signal whose potential changes to a value having a potential difference corresponding to image data with respect to a potential of the common signal in accordance with each horizontal scanning period 1h of each row, a third signal generation circuit which generates the viewing angle control signal whose potential varies in antiphase or in phase with respect to a change in potential of the common signal, and a selection circuit which selects application of the viewing angle control signal to the opposed electrode 25 of the liquid crystal display device.

FIG. 5 is a block diagram of the driving means 32. This driving means 32 is constituted of: a first signal generation circuit (which will be referred to as a common signal generation circuit hereinafter) 33 which generates the common signal C1; a second signal generation circuit (which will be referred to as a data signal generation circuit) 34 which generates a data signal whose potential changes to a value with a potential difference corresponding to image data with respect to a potential of the common signal C1; a scanning signal generation circuit 36 which generates a scanning signal (a gate signal which turns on the TFT 16) which achieves electrical conduction between the drain electrode 20 and the source electrode 21 of the TFT 16; a third signal generation circuit (which will be referred to as a viewing angle control signal generation circuit hereinafter) 37 which generates the viewing angle control signal C2 whose potential varies in antiphase or in phase with respect to a change in potential of the common signal C1; a display RAM 35 which stores signal data corresponding to image data; and a control circuit 38 which receives image data and a viewing angle selection signal and controls operations of the respective circuits 33, 34, 36 and 37 based on these signals.

The image data is supplied to the control circuit 38 from a non-illustrated external circuit. Further, the viewing angle selection signal is supplied to the control circuit 38 in accordance with selection of a viewing angle by a viewing angle selection key 7 provided in the electronic device such as a mobile phone shown in FIG. 1.

As shown in FIGS. 5 to 11, the common signal generation circuit 33 receives a clock signal from the control circuit 38, generates the common signal C1 whose potential varies in accordance with each horizontal scanning period 1 h of each row, and supplies the common signal C1 to the common electrode 14 in each pixel row of the liquid crystal display device.

On the other hand, the image data supplied to the control circuit 38 from the external circuit is supplied to the data signal generation circuit 34 by this control circuit 38. The data signal generation circuit 34 reads signal data previously stored in the display RAM 35 based on the image data, generates a data signal Don/off whose potential changes to a value having a potential difference corresponding to the image data with respect to a potential of the common signal C1 output from the common signal generation circuit 33, and supplies the data signal Don/off to the signal line 23 in each pixel row of the liquid crystal display device in accordance with each horizontal scanning period 1 h of each row.

The scanning signal generation circuit 36 receives a clock signal from the control circuit 38, generates a scanning signal which achieves electrical conduction between the drain electrode 20 and the source electrode 21 of the TFT 16, and sequentially supplies the scanning signal Sc to the scanning line 22 in each row of the liquid crystal display device in accordance with each horizontal scanning period 1 h.

The viewing angle control signal generation circuit 37 generates a signal whose potential varies in antiphase with respect to a change in phase of the common signal C1 output from the common signal generation circuit 33 (a signal obtained by reversing a cycle in which a potential of the common signal C1 changes), and the viewing angle control signal C2 having a potential whose absolute value is different from a potential of the common signal C1.

Furthermore, when a wide viewing angle is selected in accordance with the supplied viewing angle selection signal, the control circuit 38 stops an operation of the viewing angle control signal generation circuit 37, or stops output of the viewing angle control signal C2. When a narrow viewing angle is selected, the control circuit 38 generates the viewing angle control signal C2 to be output and supplies this signal to the opposed electrode 25 of the liquid crystal display device.

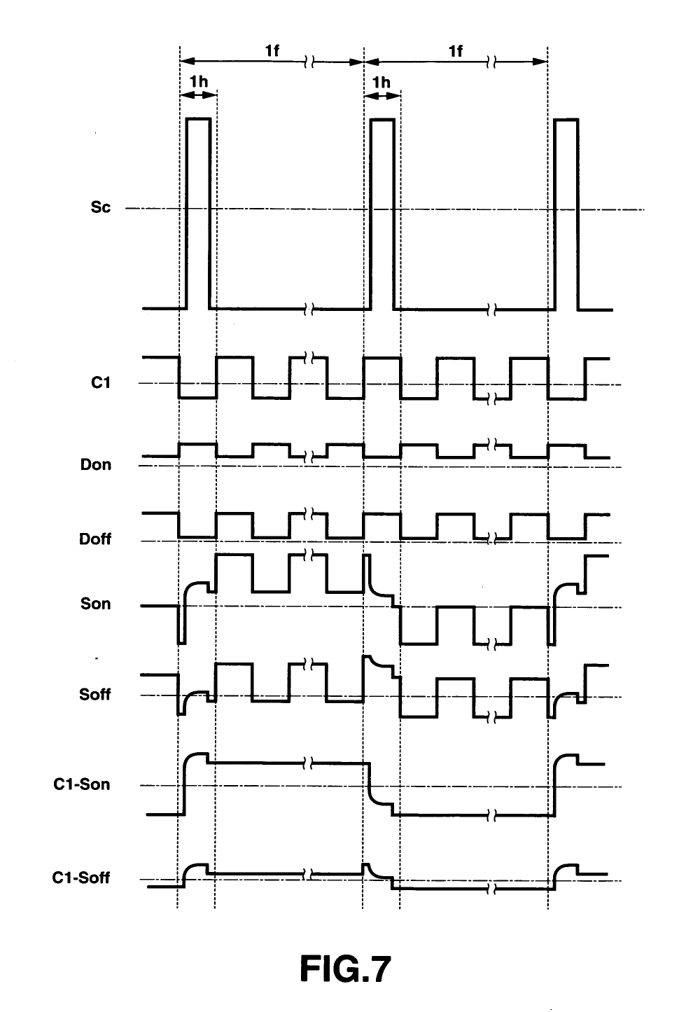

FIGS. 7 to 11 show a voltage waveform of each signal supplied to each electrode in accordance with each display mode of the liquid crystal display device, in which one frame 1f represents a period in which all the pixel rows in the liquid crystal display device are sequentially selected to display one screen and one horizontal scanning period 1h represents a selection period of one pixel row obtained by dividing one frame 1f by the number of pixel rows.

It is to be noted that the common signal C1 and the viewing angle control signal C2 may be generated by using such a signal generation circuit as shown in FIG. 6. That is, a common signal generating portion of this signal generation circuit inputs a clock signal FRP which is reversed in accordance with each horizontal scanning period 1h to an amplifier AMP and performs adjustment to obtain an arbitrary amplitude. After effecting coupling in a capacitor, the common signal generating portion outputs the common signal C1. The viewing angle control signal generating portion selects the clock signal FRP and its reversal signal based on a selection signal SE, inputs them to the amplifier AMP, and performs adjustment by this amplifier AMP to obtain an arbitrary amplitude. After effecting coupling in a capacitor, the viewing angle control signal generating portion outputs the common signal C2.

FIG. 7 shows a scanning signal Sc which is applied to the liquid crystal display device by the driving means 32, the common signal C1, a data signal Don used to display white (which will be referred to as a white data signal hereinafter), a data signal Doff which is used to display black (which will be referred to as a black data signal hereinafter), a potential Son of the signal electrode 15 to which the white data signal Don is applied through the TFT 16 (a signal electrode potential at the time of white display), a potential Soff of the signal electrode 15 to which the black data signal Doff is applied through the TFT 16 (a signal electrode potential at the time of black display), and voltage waveforms of a voltage C1-Son between the common electrode and the signal electrode at the time of white display and a voltage C1-Soff between the common electrode and the signal electrode at the time of black display.

The liquid crystal display device used in this embodiment is a display device in a normally black mode. The black data signal Doff is a signal having a potential whose potential difference is extremely small with respect to a potential of the common signal C1 or whose potential difference is substantially 0, i.e., a potential which generates between the signal electrode 15 and the common electrode 14 an extremely weak transverse electric field with which the liquid crystal molecules are aligned along the aligning treatment directions 11a and 12a of the alignment films 27 and 28 or a potential which substantially generates no transverse electric field. Moreover, the white data signal Don is a signal having a potential whose potential difference is sufficiently large with respect to the potential of the common signal C1, i.e., a potential which generates a transverse electric field having a sufficient intensity between the signal electrode 15 and the common electrode 14.

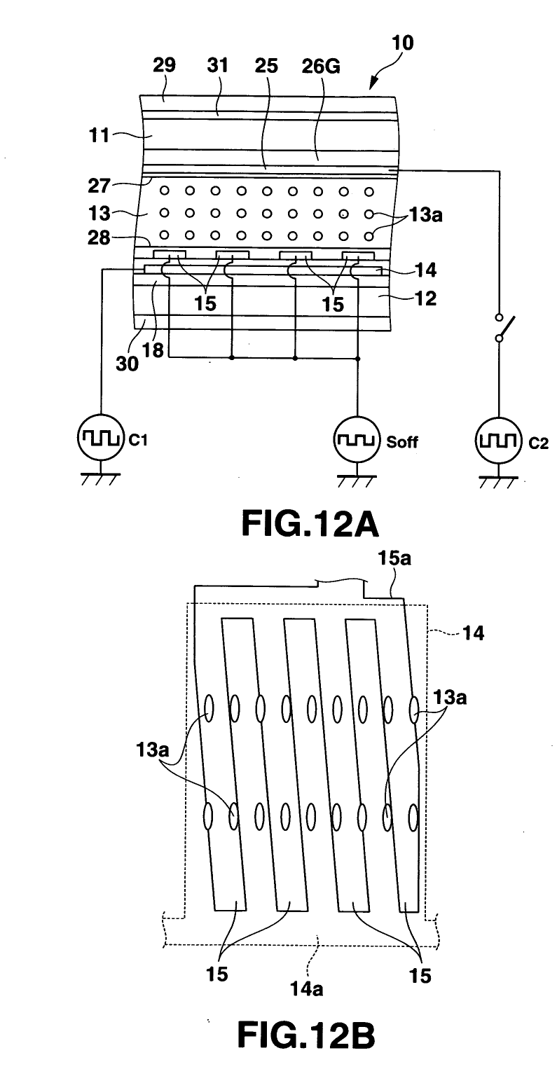

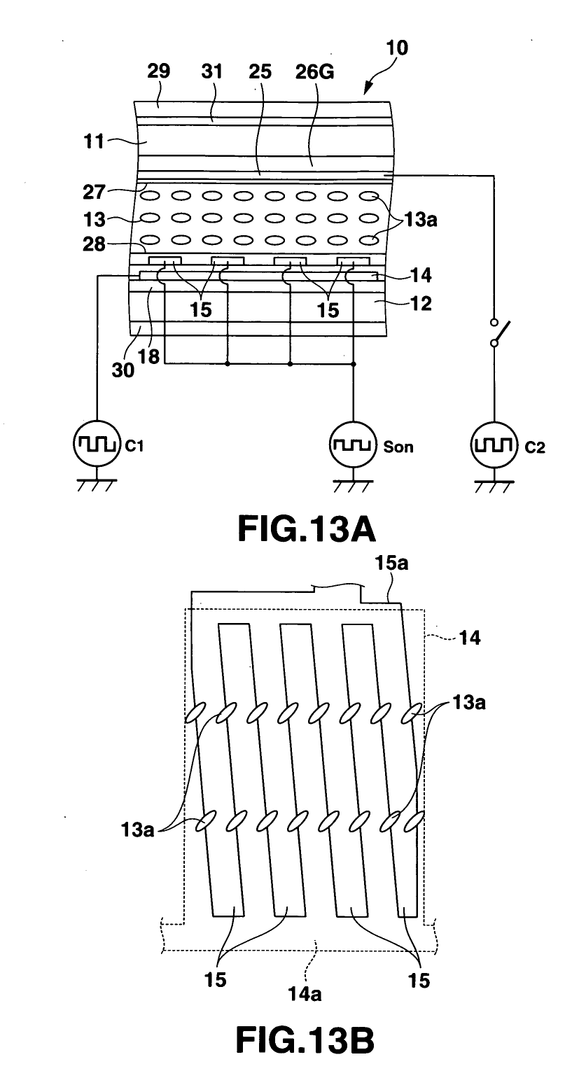

First, FIG. 12A schematically shows a case where the signal electrode potential Soff is applied to the signal electrode 15 and FIG. 12B schematically shows a change in alignment of the liquid crystal molecules at this time in a state where each signal is applied to each electrode of the liquid crystal display device when the viewing angle control signal C2 is not applied to the opposed electrode 25. Additionally, FIG. 13A schematically shows a case where the signal electrode potential Son is applied to the signal electrode 15 and FIG. 13B schematically shows a change in alignment of the liquid crystal molecules at this time.

When the viewing angle control signal C2 is not applied to the opposed electrode 25, i.e., when wide viewing angle display is performed, an alignment direction (a direction of long axes) of the liquid crystal molecules 13a of the pixel 100 is controlled within a plane substantially parallel to the surfaces of the substrates 11 and 12 by the transverse electric field alone generated between the common electrode 14 and the signal electrode 15. When the signal electrode potential Soff corresponding to black display is applied to the signal electrode 15, i.e., when an extremely weak transverse electric field corresponding to the voltage C1-Soff between the common electrode and the signal electrode shown in FIG. 7 is generated between the common electrode 14 and the signal electrode 15 (or the transverse electric field may not be substantially generated), as shown in FIGS. 12A and 12B, the liquid crystal molecules do not substantially behave in a state where their long axes are aligned in the aligning treatment directions 11a and 12a of the alignment films 27 and 28 of the substrates 11 and 12. When the signal electrode potential Son corresponding to white display is applied to the signal electrode 15, i.e., when a transverse electric field having a sufficient intensity corresponding to the voltage C1-Son between the common electrode 14 and the signal electrode 15 is generated between the common electrode 14 and the signal electrode 15, the liquid crystal molecules behave with their long axes being aligned in a direction of the transverse electric field as shown in FIGS. 13A and 13B.

As described above, when the viewing angle control signal C2 is not applied to the opposed electrode 25, an alignment direction of the liquid crystal molecules 13a varies within a plane substantially parallel to the surfaces of the substrates 11 and 12 by the transverse electric field generated between the first and second (common and signal) electrodes 14 and 15. Therefore, it is possible to perform display with a wide viewing angle corresponding to viewing angle characteristics of the transverse electric field type liquid crystal display device having small viewing angle dependence of Δnd.

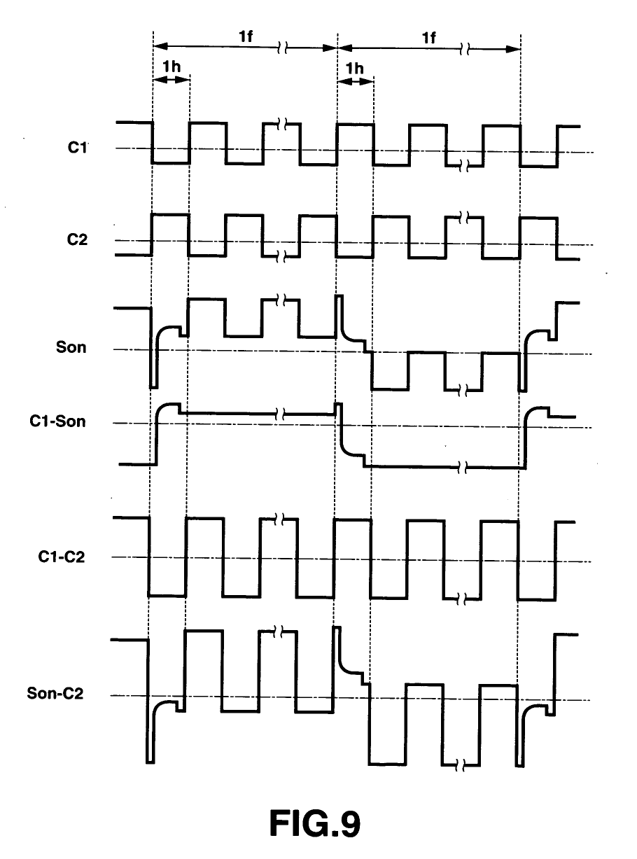

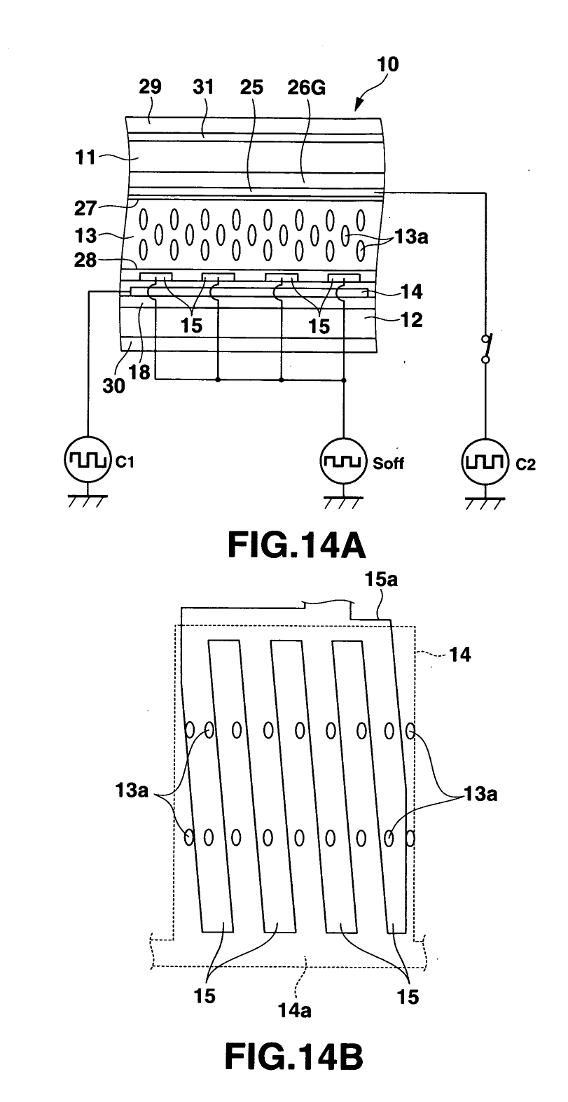

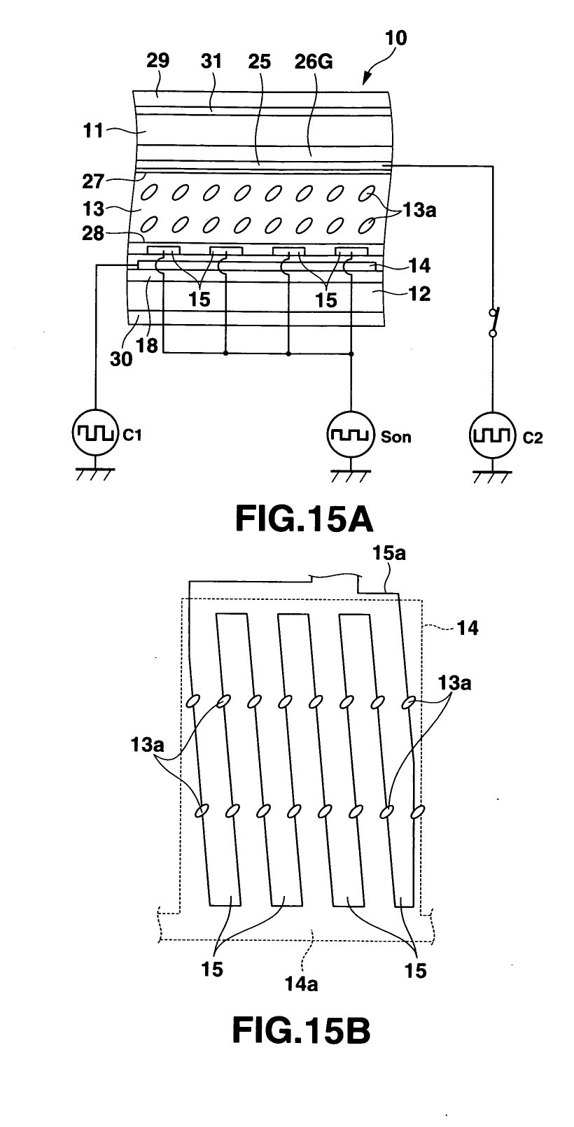

Next, FIG. 9 schematically shows a voltage waveform of each signal when the signal electrode potential Soff (at the time of black display) is applied to the signal electrode 15 in narrow viewing angle display where the viewing angle control signal C2 which is in antiphase with respect to the common signal C1 is applied to the opposed electrode 25, FIG. 14A schematically shows an application state of each signal to each electrode in the liquid crystal display device at this time, and FIG. 14B schematically shows a change in alignment of the liquid crystal molecules. Additionally, FIG. 9 schematically shows a voltage waveform of each signal when the signal electrode potential Son (at the time of white display) is applied to the signal electrode 15, FIG. 15A schematically shows an application state of each signal to each electrode in the liquid crystal display device at this time, and FIG. 15B schematically shows a change in alignment of the liquid crystal molecules at this time.

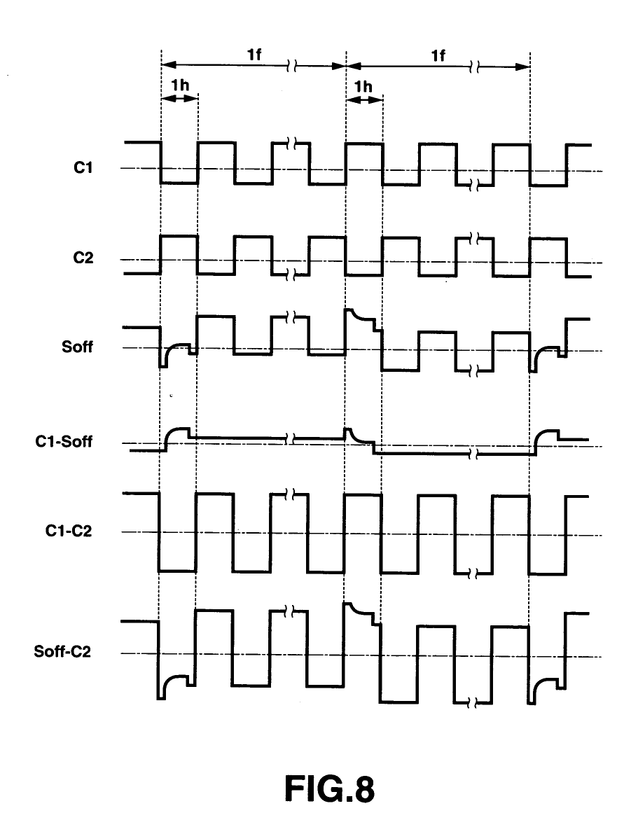

When the viewing angle control signal C2 is applied to the opposed electrode 25, i.e., when narrow viewing angle display is performed, the liquid crystal molecules 13a of the pixel 100 behave by the transverse electric field generated between the common electrode 14 and the signal electrode 15 and the vertical electric field generated between the common and signal electrodes 14, 15 and the opposed electrode 25. When the signal electrode potential Soff corresponding to black display shown in FIG. 8 is applied to the signal electrode 15, the liquid crystal molecules are aligned in a state where they obliquely rise with respect to the surfaces of the substrates 11 and 12 by the vertical electric field as shown in FIGS. 14A and 14B. Since the transverse electric field is weak, a direction of long axes of the liquid crystal molecules is not substantially changed in a state where the long axes are aligned in the aligning treatment directions 11a and 12a of the alignment films 27 and 28 of the substrates 11 and 12. When the signal electrode potential Son corresponding to white display shown in FIG. 9 is applied to the signal electrode 15, as shown in FIGS. 15A and 15B, the intensive transverse electric field allows the liquid crystal molecules to be aligned in a state where they obliquely rise with respect to the surfaces of the substrates 11 and 12 with their long axes being aligned in a direction of the transverse electric field.

As described above, when the vertical electric field is generated between the common and signal electrodes 14, 15 and the opposed electrode 25 by applying the viewing angle control signal C2 to the opposed electrode 25, the transverse electric field generated between the common electrode 14 and the signal electrode 15 allows the liquid crystal molecules 13a to be aligned in an alignment state where they obliquely rise with respect to the surfaces of the substrates 11 and 12 with their long axes being aligned in a direction of the transverse electric field. Therefore, the viewing angle dependence of Δnd of the liquid crystal display device is increased by rising of the liquid crystal molecules 13a.

Accordingly, it is possible to obtain display with excellent contrast in which there is almost no difference between display as seen from a front direction of the liquid crystal display device (a direction in the vicinity of a normal line of the liquid crystal display device) and display when the vertical electric field is not generated. On the other hand, a retardation different from that when viewing from the front direction is produced in viewing from a direction obliquely inclined from the front direction due to the large viewing angle dependence of Δnd, and display can hardly visually recognized. Therefore, a viewing angle with which display can be visually recognized with sufficient contrast is a narrow range in the front direction, thereby effecting display with a narrow viewing angle which prevents display from being peeped by persons other than a user of the liquid crystal display apparatus.

That is, in this liquid crystal display apparatus, the plurality of common electrodes 14 and signal electrodes 15 which generate a transverse electric field on the inner surface of one substrate 12 in the liquid crystal display device are provided to be insulated from each other, and the opposed electrode 25 is provided on the inner surface of the other substrate 11 in accordance with at least each entire region of the plurality of pixels 100 defined by a region in which an alignment state of the liquid crystal molecules 13a in the liquid crystal layer 13 is controlled by the transverse electric field generated between the common electrode 14 and the signal electrode 15. Further, the driving means 32 selectively applies to the opposed electrode 25 the viewing angle control signal C2 whose potential varies in synchronization with a change in potential of the common signal C1 applied to the common electrode 14 and which has a predetermined potential difference with respect to each of the potential of the common signal C1 and the signal electrode potential Son or Soff of the signal electrode 15. As a result, both display with a wide viewing angle and display with a narrow viewing angle are carried out. According to this liquid crystal display apparatus, it is possible to perform stable viewing angle control which suppresses a viewing angle from fluctuating in accordance with the image data.

As described above, in this liquid crystal display apparatus, the driving means 32 supplies the common signal C1 whose potential varies in accordance with each horizontal scanning period 1h to the plurality of common electrodes 14 which are provided in an insulating manner on the inner surface side of the pixel substrate 12 in the liquid crystal display device, and selectively supplies to the signal electrode 15 through the TFT the data signal Don or Doff having a potential with a potential difference corresponding to the image data with respect to the common signal C1, thereby giving a potential of Son or Soff to the signal electrode 15. As a result, a transverse electric field corresponding to the image data, i.e., a voltage C1-Son or C1-Soff between the common electrode 14 and the signal electrode 15 is generated between the common electrode 14 and the signal electrode 15, and an alignment direction (a direction of long axes) of the liquid crystal molecules of the plurality of pixels 100 is controlled within a plane substantially parallel to the surfaces of the substrates 11 and 12 by this transverse electric field to display an image, thus effecting display with a wide viewing angle corresponding to viewing angle characteristics of the transverse electric field type liquid crystal display device.

Furthermore, in this liquid crystal display apparatus, the driving means 32 supplies the common signal C1 to the common electrode 14 of the liquid crystal display device, and selectively supplies the data signal Don or Doff to the signal electrode 15 through the TFT. As a result, a potential of Son or Soff is given to the signal electrode 15, and a transverse electric field having an intensity corresponding to the image data, i.e., the voltage C1-Son or C1-Soff between the common electrode 14 and the signal electrode 15 is generated between the common electrode and the signal electrode. At the same time, the viewing angle control signal C2 whose potential varies in synchronization with a change in potential of the common signal C1 and which has a predetermined potential difference with respect to each of the common signal C1 and the data signal is supplied to the opposed electrode 25 provided on the inner surface side of the opposed substrate 12 of the liquid crystal display device in accordance with the entire region of the plurality of pixels 100. As a result, vertical electric fields corresponding to a potential difference between the common signal C1 and the viewing angle control signal C2 and a potential difference between the signal electrode potential Son or Soff and the viewing angle control signal C2 are respectively generated between the common electrode 14 and the opposed electrode 25 and between the signal electrode 15 and the opposed electrode 25. That is, an alignment direction of the liquid crystal molecules is controlled by the transverse electric field to display an image, and the liquid crystal molecules are obliquely raised and aligned with respect to the surfaces of the substrates 11 and 12 by the transverse electric field to restrict a viewing angle. As a result, there is carried out display with a narrow viewing angle which prevents display from being peeped by persons other than a user of the liquid crystal display apparatus.

It is to be noted that the description has been given as to the first embodiment in which an absolute value of a voltage output from a power supply device which drives the liquid crystal display device can be reduced by using the viewing angle control signal C2 whose potential varies in antiphase with respect to the common signal C1. However, when the power supply device can generate a high voltage, it is possible to use a viewing angle control signal C21 as a signal whose potential varies in phase with respect to the common signal C1.

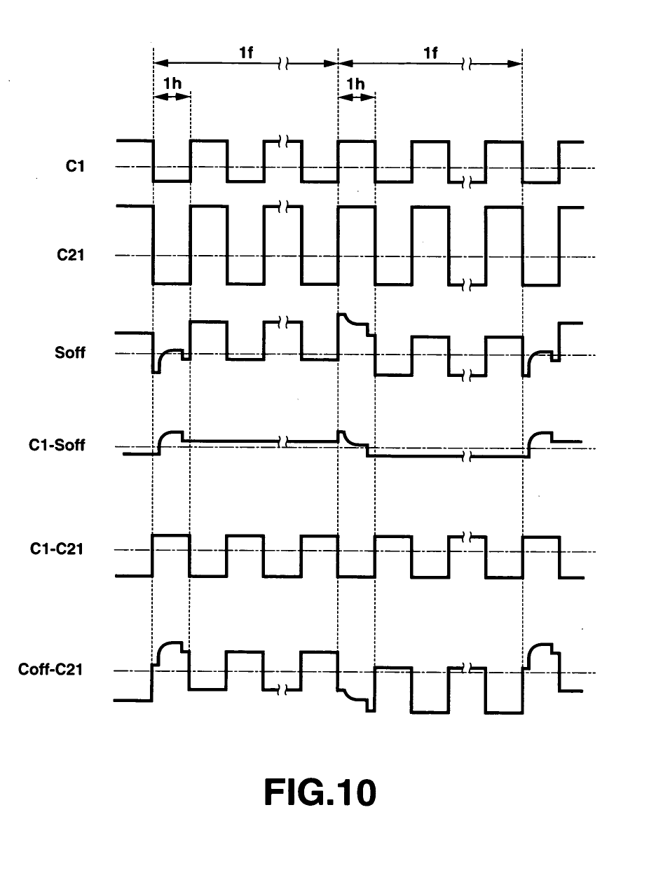

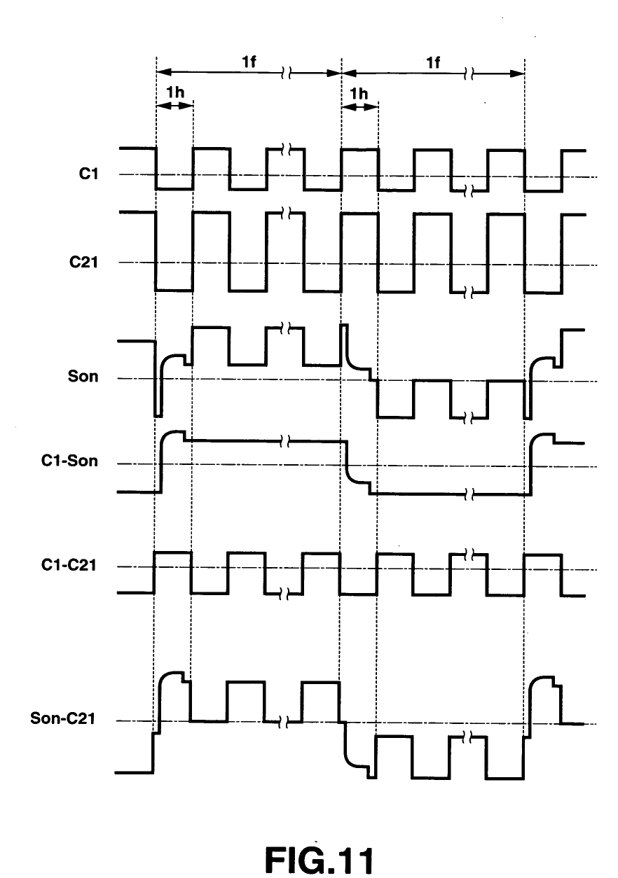

In such a case, as shown in FIGS. 10 and 11, the viewing angle control signal C21 having the same phase as the common signal C1 is supplied to the opposed electrode 25. FIG. 10 shows a voltage C1-Soff between the common electrode and the signal electrode, a voltage C1-C2 between the common electrode and the opposed electrode and a voltage Soff-C2 between the signal electrode and the opposed electrode at the time of black display (at the time of applying the signal electrode potential Soff) in this example. FIG. 11 shows a voltage C1-Son between the common electrode and the signal electrode, a voltage C1-C2 between the common electrode and the opposed electrode and a voltage Son-C2 between the signal electrode and the opposed electrode at the time of white display (at the time of applying the signal electrode potential Son) in the same example. In this liquid crystal display apparatus, like the foregoing embodiment, an alignment direction of the liquid crystal molecules is controlled by a transverse electric field to display an image, and the liquid crystal molecules are obliquely raised and aligned with respect to the surfaces of the substrates 11 and 12 by vertical electric fields, thereby effecting display with a narrow viewing angle which prevents display from being peeped by persons other than a user of the liquid crystal display apparatus.

As described above, this liquid crystal display apparatus has a configuration in which the driving means 32 selectively applies the viewing angle control signal C2 whose potential varies in antiphase with respect to a change in potential of the common signal C1 to the opposed electrode 25 of the liquid crystal display device, or a configuration in which the driving means 32 selectively applies to the opposed electrode 25 of the liquid crystal display device the viewing angle control signal C21 whose potential varies in phase with respect to a change in potential of the common signal and whose potential has an absolute value different from a potential of the common signal C1. Therefore, vertical electric fields corresponding to a potential difference between the common signal C1 and the viewing angle control signal C2 or C21 and a potential difference between the signal electrode potential Son or Soff and the viewing angle control signal C2 are respectively generated between the common electrode 14 and the opposed electrode 25 and between the signal electrode 15 and the opposed electrode 25, thereby effecting the display with a narrow viewing angle.

Moreover, in the foregoing embodiment, the driving means or circuit 32 is constituted of: first signal generating means for generating the common signal C1 whose potential varies in accordance with each row selection period; second signal generating means for generating the data signal Don or Doff which is used to supply to the second electrode a potential which varies to a value with a potential difference corresponding to image data with respect to a potential of the common signal C1 in accordance with each row selection period; third signal generating means for generating the viewing angle control signal C2 or C21 whose potential varies in antiphase or in phase with respect to a change in potential of the common signal C1; and selecting means for selecting application of the viewing angle control signal C2 to the opposed electrode 25 of the liquid crystal display device. Therefore, the common signal C1 is supplied to the common electrode 14 in the liquid crystal display device, and the signal electrode potential Son or Soff is given to the signal electrode 15, thereby selectively applying the viewing angle control signal C2 to the opposed electrode 25.

Additionally, in the liquid crystal display apparatus according to the foregoing embodiment, the liquid crystal display device is an active matrix liquid crystal display device including the plurality of active elements (TFTs) 16 each of which is arranged in accordance with each pixel, and has the input electrode (the drain electrode) 20, the output electrode (the source electrode) 21 for signals and the control electrode which controls electrical conduction between the input and output electrodes 20, 21. The control electrode is connected with the scanning line in accordance with each row, the input electrode 20 is connected with the signal line 23 in accordance with each column, and the output electrode 21 is connected with the signal electrode 15. Further, as shown in FIG. 5, the driving means 32 is constituted of: the common signal generation circuit 33 which generates the common signal C1 whose potential varies in accordance with each row selection period and supplies the common signal C1 to the common electrode 14; the data signal generation circuit 34 which generates the data signal Don or Doff which supplies to the second electrode a potential which varies to a value having a potential difference corresponding to image data with respect to a potential of the common signal C1 in accordance with each row selection period, and supplies the data signal Don or Doff to the signal line 23; the scanning signal generation circuit 36 which generates the scanning signal Sc which achieves electrical conduction between the input electrode 20 and the output electrode 21 of the active element 16 in a selected row in one horizontal scanning period, and supplies the scanning signal Sc to the scanning line 22; the viewing angle control signal generation circuit 37 which generates the viewing angle control signal C2 whose potential varies in antiphase or in phase with respect to a change in potential of the common signal C1; the control circuit 38 which controls operations of these circuits 33, 34, 36 and 37; and means for selecting supply of the viewing angle control signal C2 or C21 to the opposed electrode 25 of the liquid crystal display device in accordance with the viewing angle selection signal from the outside. Furthermore, the common signal C1 is applied to the common electrode 14 of the liquid crystal display device, the black data signal Doff or the white data Don is supplied to the signal line to give the signal electrode potential Soff or Son to the signal electrode 15, and the viewing angle control signal C2 is selectively applied to the opposed electrode 25, thereby performing stable viewing angle control in a sufficiently wide range.

Moreover, in the liquid crystal display apparatus, of the common electrode 14 and the signal electrode 15 on the inner surface side of one electrode 12 of the liquid crystal display device, the common electrode 14 is formed in accordance with at least the entire region of the pixel 100, and the signal electrode 15 is formed into a shape which has an area smaller than the pixel 100 on the interlayer insulating film 24 covering the common electrode 14 and faces the common electrode 14 at the edge portions 15c. Therefore, the transverse electric field is generated between the part of the common electrode 14 corresponding to the edge portions 15c of the signal electrode 15 and the common electrode 14, and an alignment direction of the liquid crystal molecules 13a is changed by the transverse electric field to display an excellent image. Furthermore, applying the viewing angle control signal C2 to the opposed electrode 25 generates the vertical electric field in the substantially entire region of the pixel 100, and the liquid crystal molecules 13a are obliquely raised and aligned in the substantially entire region of the pixel 100, thus performing further stable viewing angle control.

Moreover, in the foregoing embodiment, since the signal electrode 15 is formed of the comb-like electroconductive film 15a patterned into the comb-like shape having the plurality of tooth portions, the transverse electric field can be generated at many positions in the pixel 100, i.e., the respective edge portions 15c on both sides of each tooth portion of the comb-like electroconductive film 15a, and an alignment direction of the liquid crystal molecules 13a can be changed in the substantially entire region of the pixel 100, thereby displaying a further excellent image.

That is, the common electrode 14 is formed in accordance with at least the entire region of the pixel 100, and the signal electrode 15 is formed into a shape having an area smaller than the pixel 100 on the interlayer insulating film 24 covering the common electrode 14 and faces the common electrode 14 at the edge portion 15c thereof. Therefore, a transverse electric field in a direction substantially parallel to the surface of the pixel substrate 12 is generated at the part corresponding to the edge portion 15c of the signal electrode 15 (a part between the edge portion of the signal electrode 15 and the part of the common electrode 14 corresponding to the edge of the signal electrode 15) between the common electrode 14 and the signal electrode 15 by the voltage C1-Son corresponding to a potential difference between the common signal C1 and the signal electrode potential Son corresponding to the white display. The liquid crystal molecules 13a are aligned by this transverse electric field with their long axes being aligned in a direction of the transverse electric field, and the liquid crystal molecules 13a at a central part of the tooth portion 15b of the signal electrode 15 and the liquid crystal molecules 13a on the common electrode 14 placed at the center between the tooth portions 15b are likewise aligned by an influence of behaviors of the liquid crystal molecules 13a.

Additionally, in the liquid crystal display apparatus, the homogeneous alignment films 27 and 28 which define an alignment direction of the liquid crystal molecules 13a at the time of no electric field are formed on the inner surfaces of the pair of substrates 11 and 12 in the liquid crystal display device. The pair of polarizing plates 29 and 30 are arranged with the pair of substrates 11 and 12 therebetween. As shown in FIG. 4, the alignment films 27 and 28 on the inner surfaces of the pair of substrates 11 and 12 are respectively subjected to the aligning treatment in opposite directions along a direction substantially parallel to the vertical direction of the screen of the liquid crystal display device. Further, of the pair of polarizing plates 29 and 30, the polarizing plate 29 on the observation side is provided in such a manner that its transmission axis 29a becomes substantially parallel to the aligning treatment directions 11a and 12a of the alignment films 27 and 28, and the polarizing plate 30 on the opposite side of the observation side is provided in such a manner that its transmission axis 30a becomes substantially perpendicular to the transmission axis 29a of the polarizing plate 29 on the observation side. Therefore, a viewing angle in left and right directions in the screen can be controlled. Accordingly, it is possible to perform wide viewing angle display in a wide viewing angle range inclined in left and right directions at substantially the same angles with respect to the normal line of the liquid crystal display device, and narrow viewing angle display in which the viewing angle range is narrowed at each substantially equal angle from the left and right directions.

It is to be noted that the liquid crystal display device may be a normally white mode display device in which the polarizing plate 30 on the opposite side of the observation side is provided in such a manner that its transmission axis 30a becomes substantially parallel to the transmission axis 29a of the polarizing plate 29 on the observation side. In such a case, the alignment films 27 and 28 are respectively likewise subjected to an aligning treatment in opposite directions along a direction substantially parallel to the vertical direction of the screen, and the transmission axis 29a of the polarizing plate 29 on the observation side is set in substantially parallel to the aligning treatment directions 11a and 12a of the alignment films 27 and 28, thereby controlling a viewing angle in the left and right directions of the screen.

Furthermore, in the foregoing embodiment, each tooth portion 15b of the signal electrode 15 consisting of the comb-like electroconductive film 15a in the liquid crystal display device is formed into an elongated shape along a direction inclined with respect to the vertical direction of the screen in one of the left and right directions at a predetermined angle, e.g., an angle θ of 5° to 15°, and the alignment films 27 and 28 are subjected to an aligning treatment in a direction substantially parallel to the vertical direction of the screen. Therefore, the liquid crystal molecules 13a are operated to change its alignment direction in one direction by generation of the transverse electric field from a state of no electric field where the liquid crystal molecules 13a are aligned with their long axes being aligned in a direction obliquely crossing the aligning treatment directions 11a and 12a of the alignment films 27 and 28, i.e., a direction of the transverse electric field generated between the common electrode 14 and the signal electrode 15 at the predetermined angle θ, thereby displaying an image having no irregularities in luminance.

### Second Embodiment

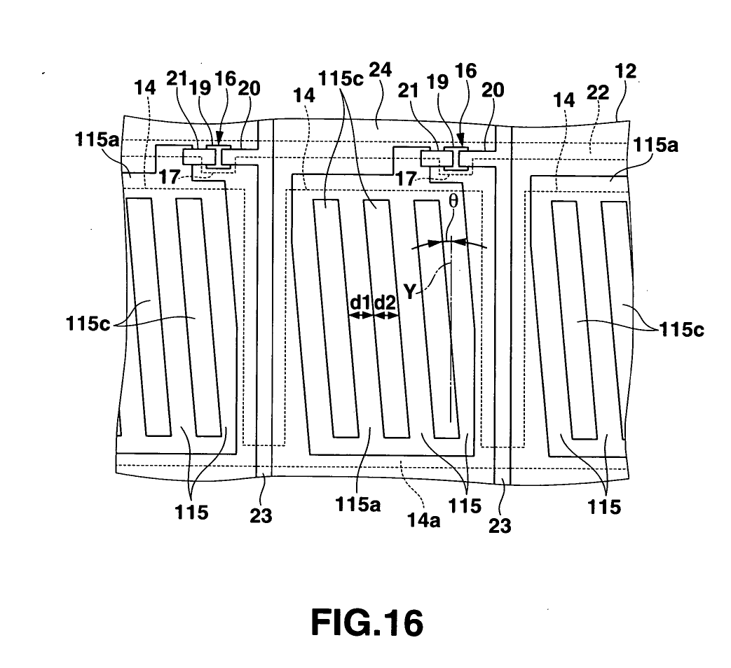

FIG. 16 is a plan view showing a part of one substrate in a liquid crystal display device according to a second embodiment of the present invention. It is to be noted that, in this embodiment, like reference numerals denote parts corresponding to those in the first embodiment, thereby eliminating their explanation.

In a liquid crystal display apparatus according to this embodiment, a signal electrode 15 on an inner surface of a pixel forming electrode substrate 12 in a liquid crystal display device is formed of a slit formed electroconductive film 115a patterned into a shape having a plurality of slits 115c along a direction inclined in one of left and right directions with respect to a vertical direction of a screen of the liquid crystal display device, i.e., a vertical axis Y of the screen at a predetermined angle, e.g., an angle θ of 5° to 15°, and other structures are the same as those in the first embodiment.

In this liquid crystal display apparatus, since a signal electrode 115 on the inner surface of the pixel forming electrode substrate 12 in the liquid crystal display device is formed of the slit formed electroconductive film 115a. Therefore, a data signal Don or Doff supplied to the signal electrode 115 from the driving means 32 shown in FIG. 5 through an active element (a TFT) 16 can be supplied to the entire signal electrode 115 without hardly decreasing a voltage, thereby obtaining a substantially constant potential in each portion of the signal electrode 115. Therefore, a transverse electric field having a homogeneous intensity can be generated at each of many positions in the pixel 100, i.e., parts corresponding to respective edge portions on both sides of the plurality of slits 115c, and an alignment direction of liquid crystal molecules 13a can be substantially evenly controlled in the substantially entire region of the pixel 100, thereby displaying a further excellent pixel. Furthermore, applying the viewing angle control signal C2 or C21 to the opposed electrode 25 can homogenize an intensity of the vertical electric field generated between the common electrode 14 and the opposed electrode 25 corresponding to at least the entire region of the pixel 100 over the substantially entire region between the common electrode 14 and the opposed electrode 25. Moreover, an intensity of the vertical electric field generated between the common electrode 14 and the signal electrode 115 formed of the slit formed electrocondutive film 115a can be homogenized over the substantially entire region between the signal electrode 115 and the opposed electrode 25, thereby effecting further stable viewing angle control.

### Third Embodiment

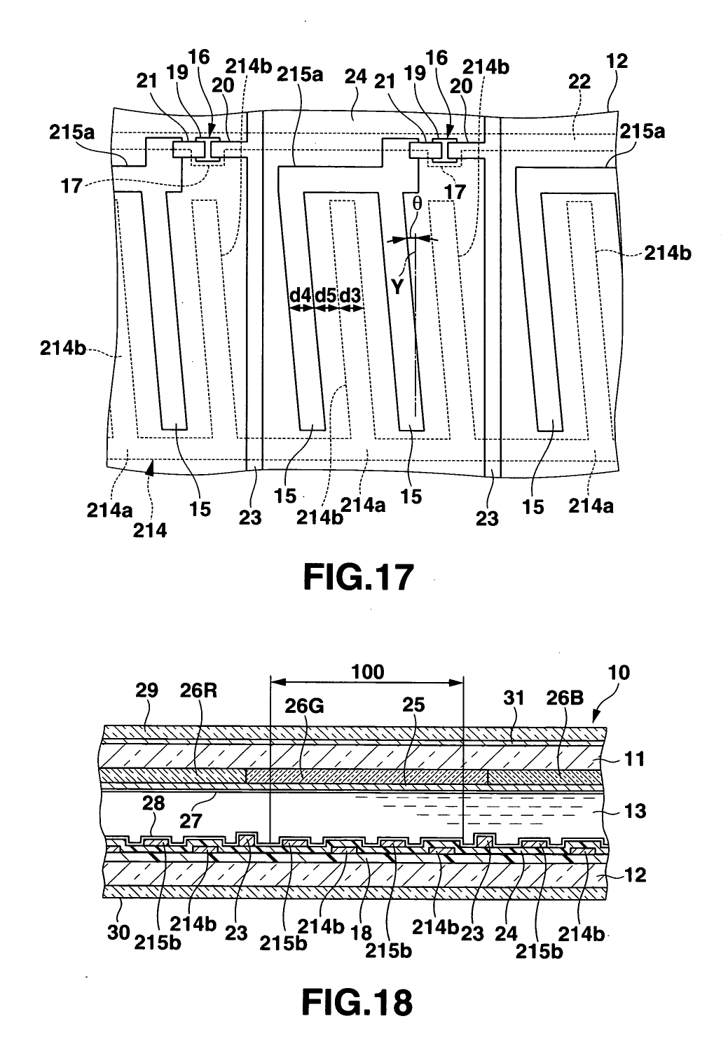

FIGS. 17 and 18 are a plan view showing a part of one substrate of a liquid crystal display device according to a third embodiment of the present invention and a cross-sectional view showing a part of the liquid crystal display device. It is to be noted that, in this embodiment, like reference numerals denote corresponding parts in the first embodiment, thereby eliminating their explanation.

In a liquid crystal display apparatus according to this embodiment, common electrodes 214 and signal electrodes 215 on an inner surface of a pixel forming electrode substrate 12 of a liquid crystal display device are provided at intervals in a direction along the surface of the substrate 12. In this embodiment, the common electrode 214 is formed of first comb-like electroconductive films 214a patterned into a comb-like shape having a plurality of tooth portions 214b along a direction inclined in one of left and right directions with respect to a vertical direction of a screen of the liquid crystal display device, i.e., a vertical axis Y of the screen at an angle θ of 5° to 15°, and the signal electrode 15 is formed of second comb-like electroconductive films 215a patterned into a comb-like shape having a plurality of tooth portions 215b which are respectively adjacent to the plurality of tooth portions 214b of the first comb-like electroconductive film 214a through a gap. Other structures are the same as those in the first embodiment.

It is to be noted that the first comb-like electroconductive film 214a forming the common electrode 214 is formed into a shape obtained by integrally connecting the comb-like electroconductive films 214b corresponding to a plurality of pixels 100 with each other in accordance with each pixel row, and the comb-like electroconductive films 214a in each row are mutually connected at end portions thereof.

Further, the second comb-like electroconductive films 215a forming the signal electrode 215 are provided in accordance with the respective pixels 100, and respectively connected with a plurality of active elements (TFTs) 16 formed on the inner surface of the pixel forming electrode substrate 12.

Furthermore, each of the tooth portions 214b and 215b of the first comb-like electroconductive film 214a and the second comb-like electroconductive film 215a is formed into an elongated shape along a direction inclined in one of left and right directions with respect to the vertical direction of the screen of the liquid crystal display device, i.e., the vertical axis Y of the screen at an angle θ of 5° to 15°. Each of ratios d5/d3 and d5/d4 of widths d3 and d4 of these tooth portions 214b and 215b and a gap d5 between the tooth portion 214b of the first comb-like electroconductive film 214a and the tooth portion 215b of the second comb-like electroconductive film 215a is set to 1/3 to 3/1, or preferably 1/1.

Moreover, alignment films 27 and 28 formed on inner surfaces of the pair of substrates 11 and 12 of the liquid crystal display device are subjected to an aligning treatment in opposite directions along a direction substantially parallel to the vertical direction of the screen 10 (the vertical axis Y of the screen). Of a pair of polarizing plates 29 and 30, the polarizing plate 29 on an observation side is arranged in such a manner that its transmission axis becomes substantially parallel to a direction of the aligning treatment, and the polarizing plate 30 on an opposite side is arranged in such a manner that its transmission axis becomes substantially perpendicular or parallel to the transmission axis of the polarizing plate 29 on the observation side.

According to this liquid crystal display apparatus, since common electrode 214 and each signal electrode 215 on the inner surface of the pixel forming electrode substrate 12 of the liquid crystal display device are provided at intervals in a direction along the surface of the substrate 12, the transverse electric field is generated between opposed edge portions of these electrodes 214 an 215. An alignment direction of liquid crystal molecules 13a is changed by the transverse electric field to display an image, and the above-described viewing angle control signal C2 or C21 is selectively applied to the opposed electrode 25 provided in accordance with at least the entire region of the pixel 100 on the inner surface of the opposed substrate 11 of the liquid crystal display device, thereby effecting stable viewing angle control.

Additionally, in this embodiment, the common electrode 214 is formed of the first comb-like electroconductive films 214a each patterned into a comb-like shape having the plurality of parallel tooth portions 214b, and the signal electrode 215 is formed of the second comb-like electroconductive films 215a each patterned into a comb-like shape having the plurality of parallel tooth portions 215b which are adjacent to the plurality of tooth portions 214b of the first comb-like electroconductive film 214a at intervals. Therefore, the transverse electric field can be generated at a plurality of positions of the pixel 100 to change the alignment direction of the liquid crystal molecules 13a, thereby displaying an excellent image.

What is claimed is:

1. A liquid crystal display apparatus comprising:
a pair of substrates arranged to face each other with a gap therebetween;
a liquid crystal layer interposed between the pair of substrates;
first and second electrodes which are provided on opposed inner surface side of one of the pair of substrates, and insulated from each other to generate in the liquid crystal layer a transverse electric field in a direction substantially parallel to the substrate surfaces;
a third electrode which is provided on an inner surface side of the other substrate in accordance with an entire region of a pixel defined by a region in which an alignment state of liquid crystal molecules is controlled by the transverse electric field generated between the first and second electrodes;
an image display circuit which supplies a display drive voltage corresponding to image data between the first and second electrodes to generate the transverse electric field between the first and second electrodes;
a viewing angle control circuit which supplies a viewing angle control voltage different from the display drive voltage between at least one of the first and second electrodes and the third electrode to generate between these electrodes a vertical electric field in a direction substantially parallel to a thickness direction of the liquid crystal layer; and
a pair of polarizing plates arranged with the pair of substrates therebetween.

2. The liquid crystal display apparatus according to claim 1, wherein, of the first and second electrodes provided on the inner surface side of one substrate, the first electrode is formed in accordance with at least the entire region of the pixel,
the second electrode is formed into a shape having an area smaller than that of the first electrode and facing the first electrode at an edge portion on an insulating film covering the first electrode, and
the viewing angle control circuit includes a viewing angle controlling voltage supply circuit which supplies the viewing angle controlling voltage between the first electrode and the third electrode provided on the inner surface side of the other substrate.

3. The liquid crystal display apparatus according to claim 2, wherein the second electrode includes a comb-like electroconductive film patterned into a comb-like shape having a plurality of tooth portions.

4. The liquid crystal display apparatus according to claim 2, wherein the second electrode includes a slit formed electroconductive film patterned into a shape having a plurality of slits.

5. The liquid crystal display apparatus according to claim 1, wherein the first and second electrodes provided on the inner surface side of one substrate are provided at intervals in a direction along substrate surfaces.

6. The liquid crystal display apparatus according to claim 5, wherein the first electrode includes a first comb-like electroconductive film patterned into a comb-like shape having a plurality of tooth portions, and
the second electrode includes a second comb-like electroconductive film patterned into a comb-like shape having a plurality of tooth portions which are adjacent to the plurality of tooth portions of the first comb-like electroconductive film at intervals.

7. The liquid crystal display apparatus according to claim 1, wherein respective alignment films are further formed on the inner surface sides of the pair of substrates, and the respective alignment films are subjected to an aligning treatment in opposite directions along a direction obliquely crossing a direction of the transverse electric field generated between the first and second electrodes at a predetermined angle.

8. The liquid crystal display apparatus according to claim 4, wherein respective alignment films are further formed on the inner surface sides of the pair of substrates, and the respective alignment films are subjected to an aligning treatment in opposite directions along a direction obliquely crossing a length direction of the edge portion of the second electrode at a predetermined angle.

9. The liquid crystal display apparatus according to claim 1, wherein respective alignment films are further formed on the inner surface sides of the pair of substrates, and the respective alignment films are subjected to an aligning treatment in opposite directions along a direction substantially parallel to a vertical direction of a screen of the liquid crystal display apparatus, and
the polarizing plate on an observation side of the pair of polarizing plates is arranged in such a manner that its transmission axis becomes substantially parallel to the aligning treatment, whilst the polarizing plate on the opposite side is arranged in such a manner that its transmission axis becomes substantially perpendicular or parallel to the transmission axis of the polarizing plate on the observation side.

10. A liquid crystal display apparatus comprising:
a liquid crystal display device including:
a pair of substrates arranged to face each other with a gap therebetween,
a liquid crystal layer interposed between the pair of substrates,
first and second electrodes which are arranged on opposed inner surface sides of one of the pair of substrates, and insulated from each other to generate in the liquid crystal layer a transverse electric field in a direction substantially parallel to substrate substrates, and
a third electrode which is provided on an inner surface side of the other substrate in accordance with an entire region of each of a plurality of pixels defined by a region in which an alignment state of liquid crystal molecules is controlled by at least the transverse electric field generated between the first and second electrodes,
the plurality of pixels being arranged in a matrix form in a row direction and a column direction; and
a drive circuit which sequentially selects the plurality of pixels arranged in the matrix form in the liquid crystal display device in accordance with each pixel row of the plurality of pixels arranged in the row direction to generate a first signal which is applied to the first electrode to control the plurality of pixels in the pixel rows in accordance with each selected pixel row and whose potential varies in accordance with each horizontal scanning period assigned to each pixel row, a second signal which has a potential difference corresponding to image data with respect to the first signal and is applied to the second electrode, and a third signal whose potential varies in synchronization with a change in potential of the first signal, has a predetermined potential difference with respect to each of the first signal and the second signal and is selectively applied to the third electrode.

11. The liquid crystal display apparatus according to claim 10, wherein the drive circuit selectively applies a signal as the third signal, whose potential varies in antiphase with respect to a change in potential of the first signal to the third electrode of the liquid crystal display device.

12. The liquid crystal display apparatus according to claim 10, wherein the drive circuit selectively applies to the third electrode of the liquid crystal display device a signal as the third signal, whose potential varies in phase with respect to a change in phase of the first signal and has an absolute value different from a potential of the first signal.

13. The liquid crystal display apparatus according to claim 10, wherein the drive circuit includes:
a first signal generation circuit which generates a signal as the first signal, whose potential varies in accordance with each horizontal scanning period;
a second signal generation circuit which generates a signal as the second signal, which supplies to the second electrode a potential which varies to a value having a potential difference corresponding to image data with respect to a potential of the first signal in accordance with each horizontal scanning period;
a third signal generation circuit which generates a signal as the third signal, whose potential varies in antiphase or in phase with respect to a change in potential of the first signal; and
selecting means for selecting application of the third signal to the third electrode of the liquid crystal display device.

14. The liquid crystal display apparatus according to claim 10, wherein the liquid crystal display device includes a plurality of active elements each of which is arranged in accordance with each pixel, and has an input electrode and an output electrode for signals and a control electrode which controls electrical conduction between the input and output electrodes, the control electrode being connected with a scanning line in accordance with each row, the input electrode being connected with a signal line in accordance with each column, the output electrode being connected with the second electrode, and
the drive circuit includes:
a common signal generation circuit which generates a signal as the first signal, whose potential varies in accordance with each horizontal scanning period and supplies the first signal to the first electrode of the liquid crystal display device;
an image signal generation circuit which generates a signal as the second signal, which supplies to the second electrode a voltage whose potential varies to a value having a potential difference corresponding to image data with respect to a potential of the first signal in accordance with each horizontal scanning period;
a scanning signal generation circuit which generates a scanning signal which achieves electrical conduction between the input electrode and the output electrode of the active element in a selected row in one horizontal scanning period, and supplies the scanning signal to the scanning line;
a viewing angle control signal generation circuit which generates a signal as the third signal, whose potential varies in antiphase or in phase with respect to a change in potential of the first signal; and
a signal selection circuit which selects supply of the third signal to the third electrode of the liquid crystal display device.

15. The liquid crystal display device according to claim 14, wherein each of the plurality of active elements includes a thin film transistor having a gate electrode connected with the scanning line, one of a drain electrode and a source electrode connected with the signal line, and the other one connected with the second electrode.

16. The liquid crystal display apparatus according to claim 10, wherein, of the first and second electrodes on the inner surface side of one substrate of the liquid crystal display device, the first electrode is formed in accordance with at least an entire region of the pixel, and the second electrode is formed into a shape having an area smaller than that of the pixel and facing the first electrode at an edge portion thereof on an insulating film covering the first electrode.

17. The liquid crystal display apparatus according to claim 16, wherein the second electrode includes a comb-like electroconductive film patterned into a comb-like shape having a plurality of tooth portions.

18. The liquid crystal display apparatus according to claim 16, wherein the second electrode includes a slit formed electroconductive film patterned into a shape having a plurality of slits.

19. The liquid crystal display apparatus according to claim 10, wherein the liquid crystal display device includes:
homogeneous alignment films which are respectively formed oh the inner surface sides of the pair of substrates, define an alignment direction of the liquid crystal molecules at the time of no electric field, and are subjected to an aligning treatment in opposite directions along a direction substantially parallel to a vertical direction of a screen of the liquid crystal display device; and
a pair of polarizing plates arranged with the pair of substrates therebetween, the polarizing plate on an observation side being provided in such a manner that its transmission axis becomes substantially parallel to the aligning treatment of the alignment films, the polarizing plate on an opposite side of the observation side being provided in such a manner that its transmission axis becomes substantially perpendicular or parallel to the transmission axis of the polarizing plate on the observation side.

20. A liquid crystal display apparatus comprising:
liquid crystal displaying means having a liquid crystal layer interposed between a pair of substrates arranged to face each other with a gap therebetween, first and second electrodes which generate in the liquid crystal layer a transverse electric field in a direction substantially parallel to the substrate surfaces, and a third electrode which generates in the liquid crystal layer a vertical electric field in a direction substantially parallel to a thickness direction of the liquid crystal layer, the liquid crystal displaying means controlling an alignment state of molecules of the liquid crystal layer by the transverse electric field in accordance with each pixel defined by a region of the liquid crystal layer whose alignment is controlled by the transverse electric field generated by the first electrode and the second electrode, thereby displaying an image by using the plurality of pixels;
image displaying means for generating a display drive signal corresponding to image data supplied thereto, and supplying the generated display drive signal to the first electrode and the second electrode to generate a transverse electric field corresponding to the image data in accordance with each of the plurality of pixels; and
viewing angle controlling means for receiving a viewing angle selection signal for selection of a viewing angle to be synchronized with the display drive signal, generating a viewing angle controlling voltage different from the display drive signal, and supplying the generated voltage to the third electrode to generate the vertical electric field in the liquid crystal layer of the plurality of pixels, thereby restricting a range of the viewing angle.
